(19) United States
(12) Patent Application Publication
(10) Pub. No.: US 2024/0011123 A1
(43) Pub. Date: Jan. 11, 2024

(54) METHODS FOR REGENERATING LI AND NI FROM A SOLUTION

(71) Applicant: BASF Corporation, Florham Park, NJ (US)

(72) Inventors: Tinoush Dinn, Beachwood, OH (US); William C. Mays, Southfield, MI (US); Martin Lawrence Panchula, Beachwood, OH (US); Dieter G. Von Deak, Beachwood, OH (US)

(21) Appl. No.: 18/039,881

(22) PCT Filed: Nov. 4, 2021
(86) PCT No.: PCT/US2021/072235

§ 371 Date: Jun. 1, 2023

Related U.S. Application Data
(60) Provisional application No. 63/119,790, filed on Dec. 1, 2020.

(51) Int. Cl. C22B 26/12; C22B 3/44; C22B 3/10; C22B 3/00; C25B 1/34; C25B 1/02

(52) U.S. Cl. CPC C22B 26/12; C22B 3/44; C22B 3/10; C22B 23/0423; C22B 23/0453; C25B 1/34; C25B 1/02

(57) ABSTRACT

Disclosed herein are methods of recycling elements, such as, e.g., lithium and/or nickel, from a solution, such as, e.g., methods of recovering reusable lithium and nickel from a waste stream produced by the delithiation of a lithium nickel oxide material.

This application claims the benefit of priority of U.S. Provisional Application No. 63/119.790, filed Dec. 1, 2020, the contents of which are herein incorporated by reference in their entirety.

Disclosed herein are methods of recycling elements, such as, e.g., lithium and/or nickel, from a solution, such as, e.g., methods of recovering reusable lithium and nickel from a waste stream produced by the delithiation of a lithium nickel oxide material.

Increased reliance on lithium-ion batteries in a wide range of technological fields has enhanced the need for cost and time efficient methods of extracting valuable elements, such as nickel and lithium, from waste streams produced during battery manufacture and recycle. Delithiation processes typically use oxidizers that generate a large amount of waste that must be processed, increasing clean up time and process costs. Moreover, recycling methods employing oxidizers may not provide for effective separation of the extracted components, thereby making individual recovery of desired materials impracticable. Such deficiencies decrease the amount of material that may be recovered and increase both the amount of waste produced and the costs associated with extraction of contaminants from an aqueous waste stream.

Additionally, multi-stage co-extractions to recover multiple materials, such as both nickel and lithium, at the same time, have been reported. These methods, while able to extract individual materials, require four co-extraction stages and six total steps in order to produce the individually extracted materials. As such, these co-extraction processes are expensive and time consuming, with each step performed in isolation and different solvents required for each step.

Thus, there is a need in the art for extraction methods with improved efficiency and yield, for example, for extracting lithium and/or nickel from a battery manufacture or recycle waste stream.

Delithiation processes are typically performed by reacting a lithiated metal oxide material with an acid to leach out the lithium. Delithiation processes are well-known in the art and include, for example, the processes described in U.S. Pat. No. 8,298,706 in which LiNiMO_{z} materials are subjected to an aqueous oxidizing mineral acid, such as, e.g., sulfuric acid, nitric acid, hydrochloric acid, perchloric acid, or oleum (i.e., fuming sulfuric acid). In alternative processes developed by the inventors, delithiation performance may be improved by using a hypochlorite salt in combination with a mineral acid. The addition of hypochlorite salt, however, presents unique challenges with respect to waste disposal or recovery of lithium, sodium, metals, or other materials from the waste stream. Thus, novel methods for recycling elements such as, e.g., lithium and/or nickel, from a waste stream produced by a delithiation process involving a hypochlorite salt and a mineral acid may be useful for improving overall manufacturing performance while reducing costs.

Disclosed herein is a process for isolating lithium and/or nickel comprising:
(A) delithiating a lithium nickel oxide (LNO) material in the presence of a mineral acid and a hypochlorite salt to produce a delithiated nickel oxide (DLNO) material and a waste stream, wherein the waste stream comprises a chloride ion, a lithium ion, and a nickel ion; and
(B1) precipitating Ni(OH)₂ from the waste stream to produce a lithium rich solution.

In some embodiments, the waste stream comprises Li at a concentration in the range of about 0.5 g/L to about 250 g/L, such as, e.g., about 20 g/L to about 150 g/L. In some embodiments, the amount of lithium present in the waste stream is from about 1 g/L to about 200 g/L, about 15 g/L, to about 175 g/L, about 20 g/L to about 150 g/L, about 25 g/L to about 125 g/L, about 30 12,1 to about 100 g/L, about 40 g/L to about 75 g/L, or about 50 g/L to about 60 g/L. In some embodiments, the waste stream comprises Li at a concentration in the range of about 0.5 g/L to about 88 g/L, such as, e.g., about 20 g/L to about 80 g/L, about 20 g/L to about 60 g/L. In some embodiments, the amount of lithium present in the waste stream is from about 1 g/L to about 88 g/L, about 20 g/L to about 60 g/L.

In some embodiments, the amount of nickel present in the waste stream is in the range from about 0.5 g/L to about 400 g/L, such as, e.g., about 20 g/L to about 200 g/L. In some aspects, the amount of nickel present in the waste stream is from about 1.0 g/L to about 300 g/L, about 15 g/L to about 250 g/L, about 20 g/L to about 200 g/L, about 25 g/L to about 150 g/L, about 30 g/L to about 100 g/L, about 40 g/L to about 75 g/L, or about 50 g/L to about 60 g/L.

In some embodiments, the lithium rich solution comprises nickel at a concentration of less than or equal to 1000 parts per million (ppm) Ni²⁺ (such as, e.g., less than or equal to 500 ppm Ni²⁺, less than or equal to 100 ppm Ni²⁺, less than or equal to 10 ppm Ni²⁺, less than or equal to 9 ppm Ni²⁺, less than or equal to 8 ppm Ni²⁺, less than or equal to 7 ppm less than or equal to 6 ppm Ni²⁺, less than or equal to 5 ppm Ni²⁺, less than or equal to 4 ppm Ni²⁺, less than or equal to 3 ppm Ni²⁺, less than or equal to 2 ppm Ni²⁺, or less than or equal to 1 ppm Ni²⁺).

In some embodiments, the lithium rich solution comprises less than 10% (such as, e.g., less than 1%, less than 0.1%, less than 0.01%, less than 0.001%, or less than 0.0001%) of the amount of Ni present in the waste stream by weight.

In some embodiments, the hypochlorite salt is chosen from calcium hypochlorite salts, lithium hypochlorite salts, and sodium hypochlorite salts.

In some embodiments, the process further comprises treating the waste stream by solvent extraction in the presence of input LiOH, input NaOH, or a combination thereof In some embodiments, the hypochlorite salt is a calcium hypochlorite salt and the process further comprises treating the waste stream by solvent extraction in the presence of input LiOH, input NaOH, or a combination thereof.

In some embodiments, the process further comprises:
(C) concentrating the lithium rich solution to produce a concentrated lithium rich solution.

In some embodiments, the lithium rich solution or the concentrated lithium rich solution comprises one or more multivalent ions (such as, e.g., aluminum, silicon, magnesium, calcium, cobalt, manganese).

In some embodiments, the process further comprises:

(D1) subjecting the lithium rich solution or the concentrated lithium rich solution to ion exchange to remove at least some multivalent ions other than Li⁺ and produce a LiCl stream.

In some embodiments, the hypochlorite salt is chosen from calcium hypochlorite salts and sodium hypochlorite salts; and step (D1) further comprises:
subjecting the lithium rich solution or the concentrated lithium rich solution to solvent extraction in the presence of input HCl to remove at least some multivalent ions to produce the LiCl stream;
separating Na from the LiCl stream using solvent extraction to produce a NaCl stream; and
optionally concentrating the LiCl stream.

In some embodiments, the process further comprises subjecting at least a portion of the NaCl stream to electrolysis to produce NaOH, a H₂ gas, and a Cl₂ gas.

In some embodiments, the process further comprises subjecting at least a portion of the H₂ gas to an HCl burner to produce HCl. In some embodiments, at least a portion of the produced HCl is recycled as a process input.

In some embodiments, the process further comprises reacting at least a portion of the Cl₂ gas with Ca(OH)₂ or NaOH air LiOH to produce calcium hypochlorite or sodium hypochlorite or lithium hypochlorite. In some embodiments, at least a portion of the produced calcium hypochlorite or sodium hypochlorite is recycled as a process input.

In some embodiments, the hpoclorite salt is a lithium hypochlorite salt; and the process further comprises:
(D2) converting the lithium rich solution or the concentrated lithium rich solution to a Li₂CO₃ stream.

In some embodiments, step (D2) comprises treating the lithium rich solution or concentrated lithium rich solution with a reagent to produce the Li₂CO₃ stream. In some embodiments, the reagent is soda ash.

In some embodiments, the process further comprises:
(E) isolating LiOH from the LiCl stream or the Li₂CO₃ stream.

In some embodiments, the isolated LiOH is in a liquid form, a crystalline form, or both. In some embodiments, at least a portion of the isolated LiOH is in liquid form. In some embodiments, at least a portion of the isolated LiOH is recycled as a process input.

in some embodiments, the process further comprises reacting at least a portion of the isolated LiOH with a Cl₂ gas to produce lithium hypochlorite. In some embodiments, at least a portion of the produced lithium hypochlorite is recycled as a process input.

In some embodiments, the process further comprises crystallizing LiOH monohydrate from at least a portion of the isolated LiOH.

In some embodiments, step (E) comprises:
(F) subjecting the LiCl stream to electrolysis to produce a LiOH liquid, a H₂ gas, and a Cl₂ gas; and
(G) precipitating LiOH monohydrate from the LiOH liquid.

In some embodiments, the process further comprises subjecting at least a portion of the H₂ gas to an HCl burner, optionally in the presence of at least a portion of the Cl₂ gas, to produce HCl. In some embodiments, the process further comprises subjecting at least a portion of the H₂ gas to an HCl burner in the presence of at least a portion of the Cl₂ gas to produce HCl. In some embodiments, at least a portion of the produced HCl is recycled as a process input.

in some embodiments, the process further comprises reacting at least a portion of the Cl₂ gas with Ca(OH)₂ to produce calcium hypochlorite. In some embodiments, at least a portion of the produced calcium hypochlorite is recycled as a process input.

In some embodiments, the process further comprises reacting at least a portion of the LiOH liquid with at least a portion of the Cl₂ gas to produce lithium hypochlorite. In some embodiments, at least a portion of the produced lithium hypochlorite is recycled as a process input.

In some embodiments, the process further comprises reacting at least a portion of the NaOH produced by electrolysis with at least a portion of the Cl₂ gas to produce sodium hypochlorite. In some embodiments, at least a portion of the produced sodium hypochlorite is recycled as a process input.

In some embodiments, step (E) comprises:
separating Li from Na in the LiCl stream using solvent extraction in the presence of input NaOH to produce NaCl;
optionally concentrating the LiCl stream to produce a concentrated LiCl stream; and
subjecting the LiCl stream or the concentrated LiCl stream to electrolysis to convert the LiCl to a LiOH liquid, a H₂ gas, and a Cl₂ gas.

In some embodiments, the process further comprises precipitating LiOH monohydrate from the LiOH liquid.

in some embodiments, the process further comprises subjecting at least a portion of the H₂ gas to an HCl burner in the presence of at least a portion of the Cl₂ gas to produce HCl. In some embodiments, at least a portion of the produced HCl is recycled as a process input.

In some embodiments, the process further reacting at least a portion of the Cl₂ gas with Ca(OH)₂ to produce calcium hypochlorite. In some embodiments, at least a portion of the produced calcium hypochlorite is recycled as a process input.

In some embodiments, the process further comprises subjecting at least a portion of the produced NaCl to electrolysis to produce NaOH. In some embodiments, at least a portion of the produced NaOH is recycled as a process input.

In some embodiments, step (E) comprises:
treating the Li₂CO₃ stream with calcium hydroxide to produce LiOH.

In some embodiments, the process is continuous. In some embodiments, a process input is produced during the operation of the process and recycled in the process.

In some embodiments, the mineral acid is chosen from sulfuric acid, nitric acid, hydrochloric acid, perchloric acid, and oleum, In some embodiments, the mineral acid is HCl.

In some embodiments, the waste stream has a pH of 2-6.

In some embodiments, the LNO material is chosen from LiNiₓM_{y}O_{z} materials, wherein:
M is chosen from metals;
x is chosen from numbers from 0 to 1.999;
y is chosen from numbers from 0 to 1.999; and
z is chosen from numbers from 1 to 4.

In some embodiments, M is chosen from transition metals, post-transition metals, and combinations thereof. In some embodiments, M is chosen from Ni, Co, Mn, Ti, Zr, Nb, Hf, V, Cr, Sn, Cu, Mo, W, Fe, Si, B, and combinations of any of the foregoing. In some embodiments, M is present at an atomic percent of 0% to 99.9% (such as, e.g., 0% to 70%, 0% to 30%, 0% to 20%, 0% to 10%, 0% to less than 10%).

In some embodiments, the LNO material is chosen from LiNiMO_{z} materials. In some embodiments, M is chosen from transition metals, post-transition metals, and combinations thereof. In some embodiments, M is chosen from Ni, Co, Mn, Ti, Zr, Nb, Hf, V, Cr, Sn, Cu, Mo, W, Fe, Si, B, and combinations of any of the foregoing. In some embodiments, M is present at an atomic percent of 0% to 99.9% (such as, e.g., 0% to 70%, 0% to 30%, 0% to 20%, 0% to 10%, 0% to less than 10%).

In some embodiments, LiNiMO_{z} material is chosen from LiNiCoAlO_{z} and LiNiCoAlM′O_{z} materials, wherein M′ is chosen from metals. In some embodiments, M′ is chosen from transition metals, post-transition metals, and combinations thereof. In some embodiments, M′ is Mg.

In some embodiments, the process further comprises forming a LNO material using Ni(OH)₂ produced by the process, LiOH monohydrate produced by the process, or both.

Also disclosed herein is a process for isolating lithium and/or nickel comprising:
(A) delithiating a lithium nickel oxide (LNO) material in the presence of a mineral acid and a calcium hypochlorite salt to produce a delithiated nickel oxide (DLNO) material and a waste stream, wherein the waste stream comprises a chloride ion, a lithium ion, and a nickel ion;
(B) precipitating Ni(OH)₂ from the waste stream to produce a lithium rich solution;
(C) optionally concentrating the lithium rich solution to produce a concentrated lithium rich solution;
(D) subjecting the lithium rich solution or the concentrated lithium rich solution to ion exchange to remove at least some multivalent ions other than Li⁺ and produce a LiCl stream;
(E) subjecting the LiCl stream to electrolysis to produce a LiOH liquid, a H₂ gas, and a Cl₂ gas;
(F) precipitating LiOH monohydrate from the LiOH liquid;
(G) reacting (i) at least a portion of the LOH liquid and/or (ii) redissolved LiOH monohydrate, with at least a portion of the Cl₂ gas to produce lithium hypochlorite; and

(H) subjecting at least a portion of the H₂ gas to an HCl burner in the presence of at least a portion of the Cl₂ gas to produce HCl.

Alternatively, processes disclosed herein may be modified to obtain purified wastewater.

### BRIEF DESCRIPTION OF THE DRAWINGS

FIG. 1A depicts a process for producing an LiNiMO_{z} materials and recycling one or more elements from that production.

FIG. 1B depicts a process for isolating Ni(OH)₂, HCl, hypochlorite, LiOH, and water from a waste stream.

FIG. 2 depicts a process for treating a waste stream produced from the use of Ca(ClO)₂ in a delithiation reaction.

FIG. 3 depicts a process for treating a waste stream produced from the use of a calcium hypochlorite salt in a delithiation reaction.

FIG. 4 depicts a process for treating a waste stream produced from the use of a lithium hypochlorite salt in a delithiation reaction.

FIG. 5 depicts an alternative process for treating a waste stream produced from the use of a lithium hypochlorite salt in a delithiation reaction.

FIG. 6 depicts a process for treating a waste stream produced from the use of a sodium hypochlorite salt in a delithiation reaction.

### NON-LIMITING EXAMPLE EMBODIMENTS

Without limitation, some embodiments of the disclosure include:
1. A process of producing LiOH monohydrate and Ni(OH)₂ from a waste stream, the process comprising:
   (A′) delithiating a LiNiMO_{z} in the presence of HCl and a hypochlorite salt to produce a delithiated LiNiMO_{z} and a waste stream (mother liquor), the waste stream comprising a Ni²⁺/Li⁺ solution comprising a chloride ion and an amount of lithium and an amount of nickel;
   (B′) treating the Ni²⁺/Li⁺ solution by solvent exchange in the presence of input LiOH, input NaOH, or a combination thereof, and-'or precipitation to produce a Ni(OH)₂ and a lithium rich solution optionally comprising one or more multivalent ions, optionally wherein said Ni(OH)₂ is used to produce said LiNiMO_{z};
   (C′) optionally concentrating e lithium rich solution to produce a concentrated lithium rich solution;
   (D′) subjecting the lithium rich solution or concentrated lithium rich solution to ion exchange remove multivalent ions other than Li⁺ to produce a LiCl stream or converting said lithium rich solution to conversion to a Li₂CO₃ stream;
   (E′) subjecting said LiCl stream or said Li₂CO₃ stream from step (D′) to isolation of LiOH, said LiOH in liquid form, crystalline form or both.
2. The process of Embodiment 1, wherein step (E′) is comprises:
   (F′) subjecting said LiCl stream to electrolysis to produce LiOH liquid, H₂ gas and Cl₂ gas, optionally wherein at least a portion of said LiOH liquid is reused as the input LiOH in step (B′);
   (G′) precipitating LiOH monohydrate from said LiOH liquid, optionally wherein said LiOH monohydrate may be used for production of said LiNiMO_{z}.
3. The process of Embodiment 2, wherein said H₂ gas is subjected to an HCl burner to produce HCl, optionally wherein said HCl is used in step (A′).
4. The process of Embodiment 2 or 3, wherein said Cl₂ gas is reacted with Ca(OH)₂ and sodium hypochlorite to produce calcium hypochlorite, optionally wherein at least a portion of said calcium hypochlorite is used in step (A′).
5. The process of Embodiment 1, wherein step (E′) comprises:
   separating Li from Na in said LiCl stream using solvent exchange in the presence of input NaOH to produce NaCl;
   optionally concentrating said LiCl stream; and
   subjecting said LiCl stream to electrolysis to convert the LiCl to LiOH liquid, H₂ gas and Cl₂ gas, optionally wherein at least a portion of said LiOH liquid is reused as the input LiOH in step (B′).

6. The process of Embodiment 5. further comprising precipitating LiOH monohydrate from said LiOH liquid, optionally wherein said LiOH monohydrate may be used for production of said LiNiMO_{z}.
7. The process of Embodiment 5, wherein said H₂ gas optionally with said Cl₂ gas is subjected to an HCl burner to produce HCl, optionally wherein said HCl is used in step (A′) or step (D′).
8. The process of Embodiment 5 or 6, wherein said Cl₂ gas is reacted with Ca(OH)₂ and sodium hypochlorite to produce calcium hypochlorite, optionally wherein at least a portion of said calcium hypochlorite is used in step (A).
9. The process of Embodiment 5, wherein said NaCl is subjected to electrolysis to produce NaOH, optionally wherein said NaOH is used as said input NaOH.
10. The process of Embodiment 1, wherein step (D′) further comprises:
   treating the lithium rich solution or concentrated lithium rich solution with soda ash or other reactant to produce said Li₂CO₃ stream.
11. The process of Embodiment 10, further comprising treating said Li₂CO₃ stream with calcium carbonate to produce LiOH.
12. The process of Embodiment 10 or 11, further comprising:
   optionally subjecting said LiOH to solvent exchange to remove multivalent ions
   optionally transferring at least a portion of said LiOH to step (B′);
   reacting at least a portion of said LiOH with Cl₂ gas to produce lithium hypochlorite, optionally wherein at least a portion of said lithium hypochlorite is used in step (A′); and
   optionally crystallizing LiOH monohydrate from said LiOH, optionally wherein said LiOH monohydrate may be used for production of said LiNiMO_{z}.
13. The process of Embodiment 1, wherein step (E′) comprises:
   subjecting said LiCl stream to electrolysis to produce LiOH liquid, H₂ gas and Cl₂ gas, optionally wherein at least a portion of said. LiOH liquid is reused as the input. LiOH in step (B′); and
   precipitating LiOH monohydrate from said LiOH liquid, optionally wherein said LiOH monohydrate may be used for production of said LiNiMO_{z}.
14. The process of Embodiment 13, further comprising reacting at least a portion of said LiOH liquid with said Cl₂ gas and sodium hypochlorite to produce lithium hypochlorite, optionally wherein at least a portion of said lithium hypochlorite is used in step (A′) as said hypochlorite salt.
15. The process of Embodiment 13 or 14, wherein said H₂ gas is subjected to an HCl burner, optionally in the presence of said Cl₂ gas, to produce HCl, optionally wherein said HCl is used in step (D′).
16. The process of Embodiment 1, wherein step (D′) comprises:
   subjecting the lithium rich solution or concentrated lithium rich solution to solvent exchange in the presence of input HCl to remove the multivalent ions to produce said LiCl stream, the process further comprising separating Na from said LiCl stream using solvent exchange to produce a NaCl stream; and
   optionally concentrating said LiCl stream.
17. The process of Embodiment 16, wherein step (E′) comprises subjecting said LiCl stream to electrolysis to convert the LiCl to LiOH liquid, optionally wherein at least a portion of said LiOH liquid is reused as the input LiOH in step (B′).
18. The process of Embodiment 16, wherein said NaCl stream is subjected to electrolysis to produce NaOH, H₂ gas and Cl₂ gas, optionally wherein at least a portion of said NaOH is used in step (B′).
19. The process of any one of Embodiments 16, 17, or 18, wherein said H₂ gas is subjected to an HCl burner to produce HCl, optionally wherein said HCl is used in step (A′), (D′), or both.
20. The process of Embodiment 18 or 19, wherein said Cl₂ gas is reacted with Ca(OH)₂ or NaOH (optionally said NaOH of Embodiment 18) to produce calcium hypochlorite or sodium hypochlorite, optionally wherein at least a portion of said sodium hypochlorite or said calcium hypochlorite is used in step (A′) as said input hypochlorite salt.
21. The process of any one of Embodiments 1-20, wherein said process is continuous.
22. The process of any one of Embodiments 1-21, wherein at least a portion of said hypochlorite salt (optionally liquid or solid) of step (A′) is produced by said process.
23. The process of any one of Embodiments 1-22, wherein the HCl in step (A′) is a product of said process.
24. The process of any one of Embodiments 1-23, wherein said input LiOH is a product produced by said process.
23. The process of any one of Embodiments 1-24, wherein M in said LiNiMO_{z} is present at an atomic percent of 0 to 99.9, optionally 0 to 70, optionally 0 to 30, optionally 0 to 20, optionally 0 to 10, optionally 0 to less than 10.
24. The process of Embodiment 23, wherein M is selected from the group consisting of Ni, Co, Mn, Ti, Zr, Nb, Hf, V, Cr, Sn, Cu, Mo, W, Fe, Si, B, other transition metals or post transition metals, or any combination thereof.
25. The process of Embodiment 24, wherein said M is Mn, Mg, Al, Co, and/or most any other transition metal or post transition metal.
26. The process of Embodiment 25, wherein said LiNiMO_{z} is LiNiCoAlO_{z}, LiNiCoAlM′O_{z} where M′ is optionally a transition metal, post-transition metal, Mg, or other.
27. The process of any one of Embodiments 1-26, wherein a pH of said waste stream is 2-6.
28. The process of any one of Embodiments 1-27, wherein said LiNiMO_{z} is formed using Ni(OH)₂ produced by the process, LiOH monohydrate produced by the process, or combinations thereof.

Provided herein are processes for obtaining reusable materials that may serve as precursors for the production of battery electrode active materials. The production of battery materials, particularly those required for use in the cathode of a lithium ion cell, requires the synthesis of precursor metal hydroxide materials that are then lithiated. The lithiation of these materials allows the crystalline electrochemically active materials to be formed during calcination with positions for lithium in the crystal structure, thereby allowing for more robust cycling when the materials are employed in batteries. For charging ; particularly charging of primary lithium ion batteries, the materials of the cathode must be delithiated. Delithiation primes the electrochemically active material for the subsequent absorption of lithium into the crystal structure during discharge.

The processes disclosed herein enable robust waste stream recycling to produce materials such as Ni(OH)₂ and LiOH monohydrate that can be supplemented back into reactions for the production of the LiNiMO_{z} materials and into further recycling reactions. As such, in some embodiments, the processes disclosed herein are continuous, meaning that at least one product of the process is fed back into an earlier stage of the recycling process or is fed back into an upstream reaction for the production or processing of an LiNiMO_{z} material.

Lithium nickel oxide materials (referred to “LNO” herein without limitation to a particular chemical formula) are typically produced by coprecipitating hydroxide reactants such as nickel hydroxide alone or with other metal hydroxides. These resulting materials are then combined with lithium hydroxide in a calcination step to form the lithium nickel oxide. LNO is then delithiated with an acid, such as, e.g., a mineral acid, such as, e.g., HCl and a hypochlorite salt (such as, e.g., a calcium hypochlorite salt, a sodium hypochlorite salt, a lithium hypochlorite salt, or combinations thereof) to produce delithiated nickel oxide (DLNO) that can be used as a cathode active material in an electrochemical cell or for other applications. DLNO is separated from the mother liquor (ML) in a solid liquid separation (SLS) step. Due to the delithiation reaction, the mother liquor may include some or all of Ni, Ca, Na, Li, and K in the form of chloride, hypochlorite, or other chloride species. Depending on which hypochlorite is used in the process, different mother liquor treatments may be employed to recover Ni(OH)₂ and LiOH monohydrate for subsequent use in further production of LNO materials.

Processes described herein may employ a waste stream produced from a LNO material.

In some embodiments, the LNO material is chosen from LiNiₓM_{y}O_{z} materials, wherein:
each of x and y is independently chosen from numbers from 0 to 1.999, or any value or range therebetween; and
z is chosen from numbers from 1 to 4, or any value or range therebetween, optionally about 2, optionally about 4.

In some embodiments, z is about 2, and each of x and y is chosen from numbers from zero to 0.999. In some embodiments, z is about 4, each of x and y is chosen from numbers from 1 to 1.999, and M is one element or a combination of elements (e.g., 2, 3, 4, 5, or more elements). Illustratively, M in the LNO materials described herein may be a metal, such as, e.g., Mn, Mg, Al, Co, and/or most any other transition metal or post transition metal, or a combination thereof. For example, the transition metal may be any transition metal suitable for use in an electrochemical cell. Illustrative examples of a transition metal include, but are not limited to, Ni, Co, Mn, Ti, Zr, Nb, Hf, V, Cr, Sn, Cu, Mo, W, Fe, Si, B, or other transition metals. Illustrative examples of LNO materials include, but are not limited to, LiNiCoMnM′O_{z}, LiNiCoMgM′O_{z}, LiNiCoAlO_{z}, or LiNiCoAlM′O_{z}, wherein M′ is optionally a transition metal, post-transition metal, Mg, or other, and may be absent in some embodiments.

A lithium compound and a nickel compound may be used to produce an electrochemically active compound, such as, e.g., a LNO material. Optionally, the lithium compound is a lithium hydroxide, lithium oxide, lithium carbonate, lithium nitrate, lithium sulfate, lithium acetate, lithium peroxide, lithium hydrogen carbonate, or a lithium halide, or any combination thereof.

The method of recovering materials from the mother liquor may vary depending on the identity of the hypochlorite salt and the recycled products targeted for isolation. “Hypochlorite salt,” as used herein, includes calcium, lithium, or sodium hypochlorite salts, or any combination thereof. In general, a waste material is provided as a source of Li and Ni for extraction or isolation by processes as provided herein. The term “waste,” as used herein, is defined as a liquid or solid composition that includes both Ni²⁺ and Li⁺ with either or both at a concentration suitable for extraction. “Waste” is not required to be a composition which is a used product of another prior process, but may be the product of an upstream process such as the leaching of Ni or Li from a prior processing step of a desired LNO material. Optionally, “waste,” as used herein, is a waste stream from a continuous or discontinuous leaching of Ni and Li, e.g., as produced during the delithiation of a LNO optionally with a mineral acid, optionally that used for the formation of a cathode in a primary or secondary electrochemical cell.

As used herein, “ppm” or “parts per million” refers to milligrams per liter (mg/L).

As used herein, “ballet grade” refers to at least 95% purity (e.g., at least 99% purity).

A LiNiMO_{z} material may be delithiated in such a way so as to yield a chloride matrix with Li and Ni that may be used for subsequent isolation per the processes as described herein. Optionally, delithiation is performed substantially by art-recognized processes, illustratively those processes described in U.S. Pat. No. 8,298,706, e.g., subjecting LiNiMO_{z} materials to aqueous hydrochloric acid or perchloric acid at a desired delithiation temperature. The aqueous acid solution can have a concentration of 1 mole/liter or more (such as, e.g., 3 moles/liter or more, 6 moles/liter or more, 8 moles/liter or more, or 10 moles/liter or more) and/or 12 moles/liter or less (such as, e.g., 10 moles/liter or less, 8 moles/liter or less, 6 moles/liter or less, or 3 moles/liter or less). Optionally, the concentration of the aqueous acid solution can be between 0.1 mole/liter and 10 mole/liter (such as, e.g., between 1 mole/liter and mole/liter, or between 4 mole/liter and 8 mole/liter). Optionally, the delithiation temperature is between 0° C. and 5° C., but in some embodiments, the delithiation temperature is 10° C. or greater, optionally 60° C. or greater. The resulting slurry is mixed at the delithiation temperature for about 0.5-40 hours, the solids either kept re-slurried or allowed to settle followed by isolation and washing of the solid delithiated material optionally for use in cathode production. The removed supernatant from the wash may be used as a waste stream Ni²⁺/Li⁺ solution in the further aspects of the processes as provided herein.

The waste stream (mother liquor) from the delithiation process may be referred to herein as a Ni²⁺/Li⁺ solution and, in some embodiments, may include Li at a concentration in the range from about 0.5 g/L to about 250 g/L, such as, e.g., from about 20 g/L to about 150 g/L. In some embodiments, the amount of lithium present in the Ni²⁺/Li⁺ solution is from about 1 g/L to about 200 g/L. about 15 g/L to about 175 g/L, about 20 g/L to about 150 g/L, about 25 g/L to about 125 g/L, about 30 g/L to about 100 g/L, about 40 g/L to about 75 g/L, or about 50 g/L to about 60 g/L.

In some embodiments, the amount of nickel present in the Ni²⁺/Li⁺ solution may range from about 0.5 g/L to about 400 g/L, optionally from about 20 g/L to about 200 g/L. In some aspects, the amount of nickel present in the Ni²⁺/Li⁺ solution is from about 1.0 g/L to about 300 g/L, about 15 g/L to about 250 g/L, about 20 g/L to about 200 g/L, about 25 g/L to about 150 g/L, about 30 g/L to about 100 g/L, about 40 g/L to about 75 g/L, or about 50 g/L to about 60 g/L.

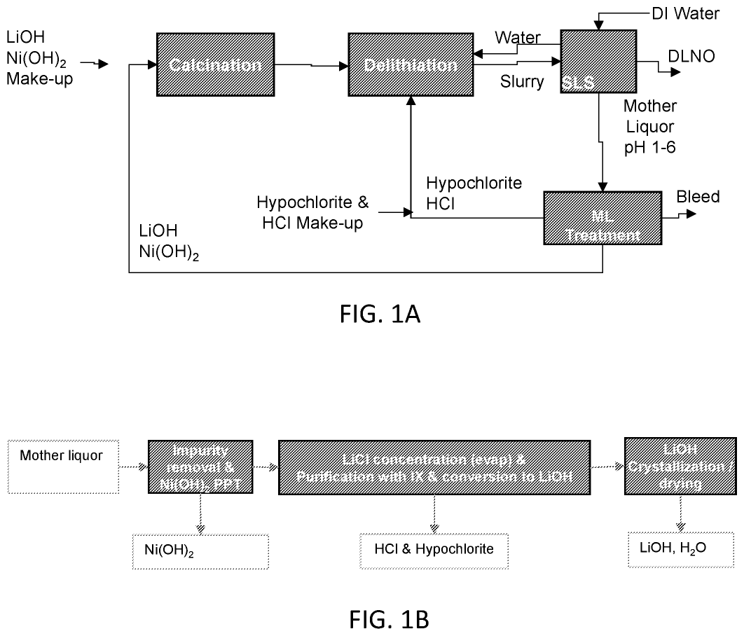

A generalized procedure for treating a Ni²⁺/Li ⁺solution to generate Ni(OH)₂ and LiOH monohydrate is illustrated in FIG. 1B. A waste stream in the form of a Ni²⁺/Li⁺ solution is subjected to a solvent extraction reaction and/or a precipitation reaction to precipitate Ni(OH)₂ and/or remove multivalent ions or other impurities that may affect subsequent processing steps. The precipitated Ni(OH)₂ may be used as a precursor material for the production of further LNO materials. Also produced is a lithium rich solution that may include lithium in the form of lithium chloride. The LiCl stream may be subjected to further purification steps to produce and isolate LiOH (liquid) and regenerate HCl and optionally a hypochlorite salt that itself may be reused for the production of further DLNO materials. The LiOH (liquid) may itself be used for subsequent Ni precipitation reactions in the recycling process itself. Optionally, at least a portion of the LiOH (liquid) may then be crystallized to form a LiOH monohydrate material that may itself be used in the production of LNO materials. Overall, the treatment produces Ni(OH)₂ and LiOH monohydrate that can be reused for the production of LNO materials. In some embodiments, the processes also produce HCl and/or a hypochlorite salt that can also be used in a delithiation reaction, such as, e.g., delithiation of a LNO material. In some embodiments, a process provided herein is continuous and may be run in concert with DLNO production processes to continually both produce subsequent DLNO materials, but also support the recycling of Ni and Li in the waste stream from the delithiation processes during the production of DLNO materials.

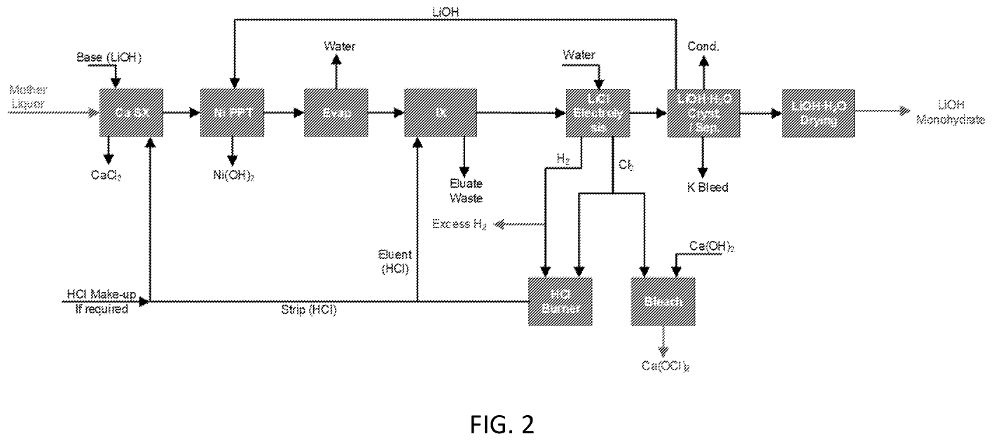

Some embodiments of this disclosure provide processes of producing a recycled material from a waste stream, wherein the recycled material may include at least LiOH monohydrate and Ni(OH)₂. In some embodiments, a process of treating a waste stream produced from the use of Ca(ClO)₂ in a delithiation reaction is as illustrated in FIG. 2. Briefly, nickel and calcium are removed by precipitation and/or solvent extraction. For the Ca solvent extraction (SX), HCl produced in a later step following electrolysis may be used to strip calcium. For the Ni precipitation, an input LiOH may be used to provide enough base to cause precipitation; in some embodiments, the input LiOH is produced in the recycling process in whole or in part.

Illustratively, Ni precipitation may be performed as described in U.S. Patent Application Publication No. 2021/0130927 A1. In some embodiments, Ni(OH)₂ may be recycled back to the calcination step. The stream is optionally concentrated using evaporation or other techniques to reduce the hydraulic load in the downstream process and to reduce equipment size. Then, the multivalent impurities are removed using ion exchange (IX) in a process that may use, at least in part, HCl produced later in the same process. Alternatively, multivalent impurities are removed using ion exchange (IX) before the stream is optionally concentrated using evaporation (i.e., in some aspects, the ion exchange step is performed prior to the concentration step). Optionally, the concentration step is excluded. Next, the resulting LiCl stream is passed through electrolysis to convert the LiCl to LiOH. Part of the LiOH may be recycled back to the Ni precipitation step as the input LiOH. Battery grade LiOH monohydrate crystal may be produced from the LiOH in the crystallization step and may, in some aspects, be recycled back to the calcination step in the production of LNO materials.

As illustrated in FIG. 2, the LiCl electrolysis step generates H₂ and Cl₂. At least a portion of the H₂ and/or at least a portion of the Cl₂ from the electrolysis step may optionally be used to generate HCl that can be used in the delithiation reaction to produce DLNO. In some embodiments, another portion or the rest of the Cl₂ gas and fresh Ca(OH)₂ may be reacted to produce Ca(ClO)₂. HO and Ca(ClO)₂ may be recycled back to the delithiation and/or solvent extraction (SX) or ion exchange (IX) steps. Additionally, the Ca(ClO)₂ may be reused in the delithiation reaction.

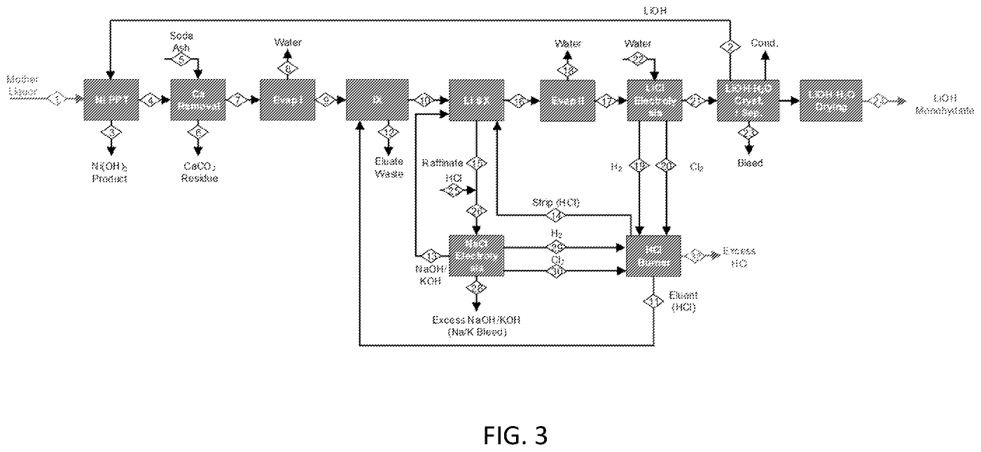

In some embodiments, a process that may be used following delithiation with a calcium hypochlorite is as illustrated in FIG. 3. Briefly, nickel and calcium may be removed with precipitation or solvent extraction. Optionally, the Ca is removed by reaction with soda ash to produce a calcium carbonate residue and a lithium rich solution. Ni(OH)₂ may be recycled back to the calcination step during production of LNO materials. The lithium rich solution is optionally concentrated using evaporation or other techniques to reduce the hydraulic load in the downstream process and to reduce equipment size. Then, the multivalent ion impurities are removed using ion exchange (IX). Alternatively, the multivalent ion impurities are removed using ion exchange (IX) before the lithium rich solution is optionally concentrated. In the next step, Li is separated from Na using solvent extraction (SX) (such as, e.g., solvent extraction processes described in U.S. Patent Application Publication No. 2021/0130927 A1). The recovered LiCl stream is optionally further concentrated, followed by electrolysis to convert the LiCl to LiOH. Part of the LiOH may be recycled back to the Ni precipitation step. Battery grade LiOH monohydrate crystal is produced in the crystallization step and may be recycled back to the calcination step. In some embodiments, electrolysis may be used to convert NaCl, produced in the separation of Li from Na, to NaOH that may be used in the Li/Na separation step. The generated H₂ and Cl₂ from each electrolysis step may be used to generate HCl. NaOH and HCl may recycled back to the Li solvent extraction, ion exchange, and delithiation steps.

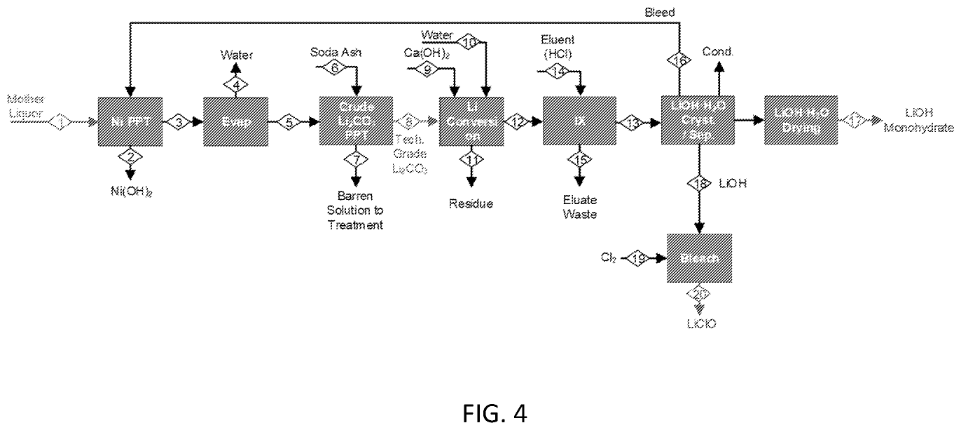

In some embodiments, a waste stream may be produced by delithiation of LNO with a lithium hypochlorite salt. Processing of this Ni²⁺/Li⁺ solution may be performed, e.g., as depicted in FIG. 4. Briefly, nickel is removed by precipitation (such as, e.g., precipitation with input LiOH) or solvent extraction. Ni(OH)₂ may be recycled hack for production of LNO materials. The lithium rich stream is optionally concentrated using evaporation or other techniques to reduce the hydraulic load in the downstream process and to reduce equipment size. Technical grade lithium carbonate (Li₂CO₃ stream) is produced by reaction with soda ash, then converted to LiOH using Ca(OH)₂. Additional multivalent impurities are then removed using ion exchange. In the next step, part of the LiOH may be recycled back to the Ni precipitation step. Another portion of LiOH may be reacted with Cl₂ gas to produce LiClO and recycled back to the delithiation reaction. Battery grade LiOH crystal is produced from the LiOH in crystallization step and recycled back to the calcination step.

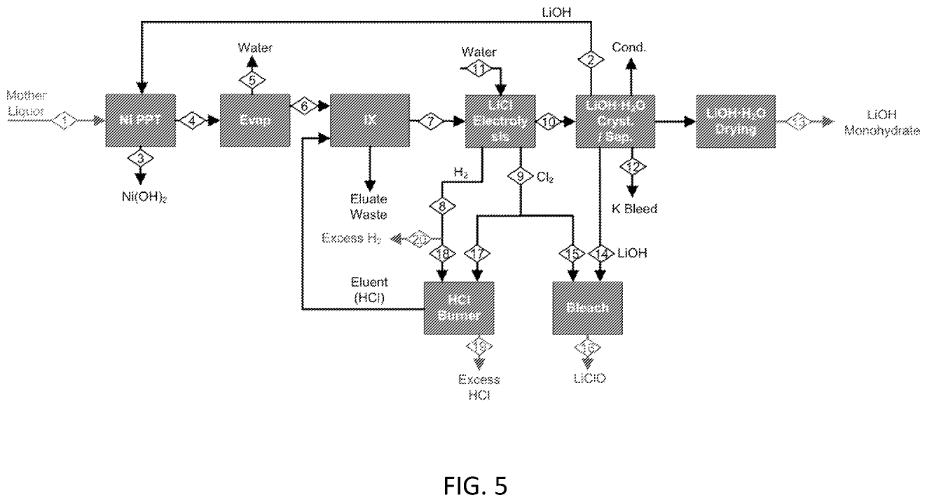

In other embodiments, when lithium hypochlorite is used in the delithiation reaction, the waste stream may be recycled as illustrated in FIG. 5. This process, which is similar in some aspects to the processes depicted in FIG. 2 and FIG. 3, includes production of a LiCl steam and subsequent lithium electrolysis. Briefly, the Ni is removed by precipitation (optionally with input LiOH) or solvent extraction (optionally as described in U.S. Patent Application Publication No. 2021/0130927 A1), Ni(OH)₂ may be recycled back to production of subsequent LNO materials. The lithium rich solution may then be concentrated using evaporation or other techniques to reduce the hydraulic load in the downstream process and to reduce equipment size. Additional multivalent impurities may be removed using ion exchange to produce a LiCl steam. Alternatively, additional multivalent impurities may be removed using ion exchange prior to concentration of the lithium rich solution. Next, electrolysis may be used to convert the LiCl steam to LiOH. Part of the LiOH may be recycled back to the Ni precipitation step as input LiOH. Battery grade LiOH crystal may be produced in a crystallization step from a part of the LiOH and may be recycled back for production of subsequent LNO materials. In some embodiments, the generated H₂ and Cl₂ from the electrolysis step may be used to generate LiClO and HCl that may be recycled back to the delithiation reaction and ion exchange steps, respectively.

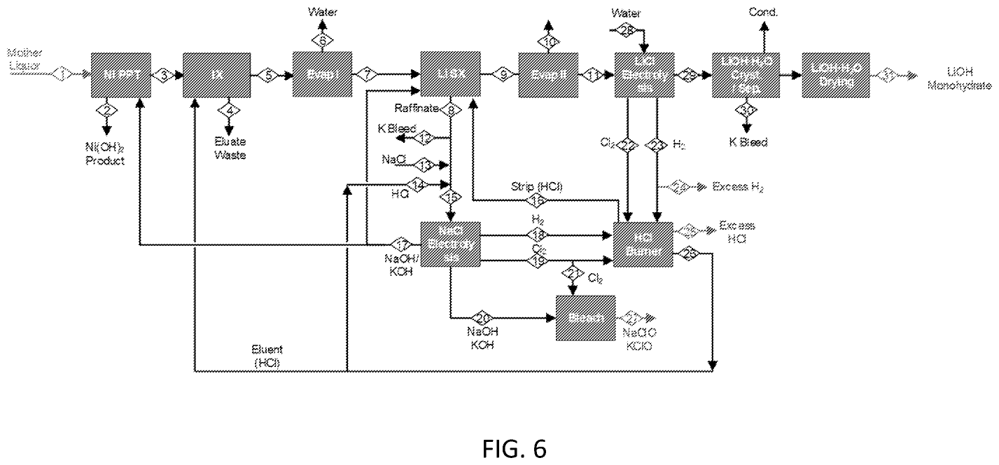

In some embodiments, the delithiation reaction is performed using a sodium hypochlorite salt. In some embodiments, recycling of the waste stream produced in this delithiation may be performed as depicted in FIG. 6. Briefly, nickel is removed with precipitation or solvent extraction (optionally as described in U.S. Patent Application Publication No. 2021/0130927 A1). Ni(OH)₂ may be recycled back to the production of LNO materials. The resulting lithium rich solution may then be concentrated using evaporation or other techniques to reduce the hydraulic load in the downstream process and to reduce equipment size. Then, the rest of multivalent impurities removed using ion exchange to produce a LiCl stream. Alternatively, the multivalent impurities may be removed using ion exchange prior to concentration of the lithium rich solution. In next step, Li is separated from Na using solvent extraction (optionally as described in U.S. Patent Application Publication No. 2021/0130927 A1). The recovered LiCl stream is optionally further concentrated. The resulting LiCl stream is optionally subjected to lithium solvent extraction to separate out NaCl followed by electrolysis to convert the LiCl to LiOH, Part of the LiOH may be recycled back to the Ni precipitation step as input LiOH. Battery grade LiOH monohydrate crystal may be produced in a crystallization step and then may be recycled back to the calcination step in the production of LNO materials. Also as illustrated in FIG. 6, electrolysis may be used on the NaCl stream produced from the Na/Li separation step to generate NaOH. Part of NaOH air LOH may be recycled back to precipitate Ni. The generated H₂ and Cl₂ from each electrolysis may be used to generate HCl and NaClO, which may be recycled back to the IX step and the delithiation step. respectively.

Illustrative aspects of non-limiting processes for producing LiOH monohydrate and Ni(OH)₂ from a waste stream described herein are illustrated in Table 1.

TABLE 1
Example Process Steps with Common Steps Bolded

| | | | | LiCl concentration (evap), | | | | | | | | |
|---|---|---|---|---|---|---|---|---|---|---|---|---|
| | | | | purification with IX & conversion to LiOH | | | | | | | | LIOH |
| | Impurity removal & | | | Regeneration of HCl, NaOH, KOH & hypochlorite | | | | | | | | Regen |
| | Ni(OH)₂ ppt | | | | LiCl to | | | | | | | LIOH |
| | | Ca | Ni | | Li₂CO₃ | | Li | Li | Na | Hypochlorite | | Crys & |
| Technologies | CaSX | PPT | ppt | Evap | to LiOH | IX | SX | Electrolysis | Electrolysis | Regeneration | HCl | Drying |
| FIG. 2 | X | | X | X | | X | | X | | X | X | X |
| Ca(ClO)₂ | | | | | | | | | | | | |
| FIG. 3 | | X | X | X | | X | X | X | X | | X | X |
| Ca(ClO)₂ one | | | | | | | | | | | | |
| pass | | | | | | | | | | | | |
| FIG. 4 | | | X | X | X | X | | | | X | | X |
| LiClO from | | | | | | | | | | | | |
| conversion | | | | | | | | | | | | |
| FIG. 5 | | | X | X | | X | | X | | X | X | X |
| LiClO | | | | | | | | | | | | |
| electrolysis | | | | | | | | | | | | |
| FIG. 6 | | | X | X | | X | X | X | X | X | X | X |
| NaClO | | | | | | | | | | | | |
| electrolysis | | | | | | | | | | | | |

In some embodiments, extracting Ni from the Ni²⁺/Li⁺ solution is optionally performed by direct precipitation of Ni, such as, e.g., with an input LiOH to produce Ni(OH)₂. Illustratively, the input LiOH will provide sufficient base that the pH of the Ni²⁺/Li⁺ solution is adjusted to a pH of about 8 to about 12.5, optionally about 10 to about 12.5. It is appreciated that the input LiOH may be substituted with other base materials, such as, e.g., NaOH, as illustrated in FIG. 6. The input LiOH or NaOH may be contacted with the Ni²⁺/Li⁺ solution in a chamber and held at a desired time and for a desired temperature, optionally −5° C. to 120° C., to allow formation of the Ni(OH)₂.

Nickel precipitation may be performed in a circuit that includes a set of reactor tanks, followed by a thickener and a filter. The thickener overflow is sent to calcium removal, while the underflow is sent to a solid-liquid separation device (such as, e.g., a filter press). The filter cake product, mainly comprising nickel hydroxide, is considered reusable for subsequent production of LNO materials or other uses.

The resulting precipitated Ni product may be subsequently filtered and washed so as to form the final Ni(OH)₂ material, which may be directly utilized for subsequent production of LNO materials, optionally for the production of lithiated cathode electrochemically active materials.

Isolation of Ni results in a lithium rich solution that includes Ni optionally at a concentration of less than or equal to 1000 parts per million (ppm) Ni²⁺ (such as, e.g., less than or equal to 500 ppm Ni²⁺, less than or equal to 100 ppm Ni²⁺, less than or equal to 10 ppm Ni², less than or equal to 9 ppm Ni²⁺, less than or equal to 8 ppm Ni²⁺, less than or equal to 7 ppm Ni²⁺, less than or equal to 6 ppm Ni²⁺, less than or equal to 5 ppm Ni²⁻, less than or equal to 4 ppm Ni²⁺, less than or equal to 3 ppm Ni²⁺, less than or equal to 2 ppm Ni²⁺, or less than or equal to 1 ppm Ni²⁺).

The lithium rich solution optionally has less than 10 percent the amount of Ni as the Ni²⁺/Li⁺ solution by weight. In some embodiments, the lithium rich solution has less than 1 percent the amount of Ni in the Ni²⁺/Li⁺ solution, such as, e.g., less than 0.1 percent, less than 0.01 percent, less than 0.001 percent, or less than 0.0001 percent the amount of Ni in the Ni²⁺/Li⁺ solution by weight.

As illustrated in FIG. 2, when the delithiation reaction utilizes calcium hypochlorite in the delithiation solution, a calcium removal step may be added. In FIG. 2, such a step is depicted as Ca SX (i.e., calcium solvent extraction). Ca²⁺ in the Ni²⁺/Li⁺ solution may be extracted using an organic extractant, such as, e.g., di-(2-ethylhexyl) phosphoric acid (D2EPHA) with formula (C₈H₁₇O)₂PO₂H. In some embodiments, the organic extractant may comprise a maximum 30% v/v of D2EPHA. In some embodiments, the extraction may be performed at a pH of about 3. NaOH may be added to maintain the pH after extraction of Ca²⁺. The loaded extractant with Ca²⁺ may be stripped off by HCl to generate Ca(Cl)₂ at acidic pH (e. g , a pH of 1 -2) and a concentration of about 3-6 mol/L. The resulting lithium rich solution may be used for subsequent processing.

As illustrated in FIG. 3, when calcium hypochlorite is used in the delithiation reaction, calcium may be precipitated from the Ni²⁺/Li⁺ solution, optionally in a series of agitated tanks. The concentration of calcium in the solution is optionally reduced to a maximum of 100 mg/L by the addition of soda ash (Na₂CO₃) as a 25% w/w solution, forming calcium carbonate. The discharge slurry is filtered and the filter cake, consisting primarily of calcium carbonate, is disposed of or employed in other processes. The resulting lithium rich solution is then used for subsequent processing.

Lithium hypochlorite may be used in some aspects as a hypochlorite salt for the delithiation reaction. In some embodiments, such as an embodiment illustrated in FIG. 4, the lithium rich solution is subjected to conversion of the lithium to lithium carbonate. Briefly, the lithium rich solution is heated to 90-95° C., and Li₂CO₃ is precipitated out of the purified mother liquor stream by the addition of soda ash, producing a Li₂CO₃ slurry. This discharge slurry is filtered, and Li₂CO₃ solids are washed to produce an intermediate technical-grade Li₂CO₃ product. The intermediate Li₂CO₃ product steam is sent to lithium conversion, as illustrated in FIG. 4. Barren solution containing the sodium and potassium impurities may be sent to an effluent treatment plant.

The lithium conversion depicted in FIG. 4 may be performed by feeding the lithium carbonate in a train of agitated reactors configured in series. A hydrated lime slurry is added that reacts with the lithium carbonate feedstock to produce a LiOH solution and an insoluble calcium carbonate precipitate. Process condensate may be added to the reactors to achieve a target outlet concentration of 2 wt % LiOH. The resultant slurry may be fed to a bank of filter presses (operating in parallel and configured in a duty/standby arrangement) to remove any residual solids from the LiOH solution. The solid cake (70 wt % solids), which contains primarily calcium carbonate and a small amount of residual unreacted lithium carbonate, may be disposed of.

Additionally, as illustrated in FIGS. 2-6, a process disclosed herein may include an ion exchange step to remove multivalent ions. In some embodiments, the ion exchange media with a high affinity for tri- and di-valent metal ions is loaded, washed with process condensate, and then eluted with a dilute hydrochloric acid solution. The purified raffinate (LiCl solution) containing less than 1 ppm of the tri and divalent metal ions is fed to the next unit operation in the respective processes. A weakly acidic microporous cation exchange resin (e.g., with functional group of iminodiacetic acid or aminophosphonic) can be used. Commercially available cation exchange resins include, but are not limited to. Lanxess TP-207.

As illustrated in FIGS. 3 and 6, in some embodiments, the process may include a lithium solvent extraction to separate sodium from the lithium rich solution. In some embodiments, lithium is selectively extracted into an organic solution using lithium solvent extraction process, leaving impurities such as sodium and potassium in the raffinate. A portion of the raffinate solution, which mostly contains sodium chloride and some potassium chloride, may be bled to prevent the build-up of potassium as illustrated in FIG. 6. In some embodiments, sodium hydroxide produced in NaCl electrolysis is added as a pH modifier. The lithium loaded organic is then scrubbed, using a weak acid solution, to remove entrained and co-extracted impurities. After scrubbing, lithium is stripped from the organic phase with hydrochloric acid (HCl), producing a lithium chloride solution. Any residual organic is removed from the strip and raffinate solutions using multi-media filters. The LiCl stream may be fed to LiCl electrolysis, when used. The raffinate solution, which mostly contains sodium and potassium chloride, may be sent to NaCl electrolysis for the production of NaOH, H₂, and Cl₂ gases that themselves may be used downstream.

As illustrated in FIGS. 2, 3, 5, and 6, in some embodiments, the stream may be subjected to lithium electrolysis, The LiCl stream from a prior step is fed to the LiCl electrolysis in a 2-compartment divided bipolar cell. As an electric current is applied, chlorine gas is generated at the anode and hydrogen at the cathode. The hydrogen and chlorine gases may be sent to an HCl Burner, where the gases are converted to hydrochloric acid. With the electric current applied across the electrolysis cell, metal ions present in the lithium chloride brine cross the membrane to maintain the charge balance and produce lithium hydroxide on the cathode side. Water is added as the catholic compartment dilution water source. The lithium hydroxide rich solution may then be reused or sent to LiO·H₂O crystallization. A purge may be required periodically at the analyte discharge to avoid the build-up of impurities. Single cell voltage can be up to about 5 V and operation amperage up to about 2-4 kA/m².

As illustrated in FIGS. 3 and 6, in some embodiments, NaCl removed from the LiCl stream may be subjected to NaCl electrolysis to produce NaOH, H₂, and Cl₂ that may all be reused in other points in the process. In the NaCl electrolysis circuit, the saturated brine solution is fed to membrane electrolysis where an electric current is supplied to drive electrochemical reactions that produce chlorine gas in the anode compartment, and hydrogen gas, sodium, and potassium hydroxide in the cathode compartment. The semi-permeable membrane between the anode and cathode selectively permits sodium ions (Na³) and water molecules to pass through the membrane but prevents the passage of chloride ions (Cl⁻) and hydroxyl ions (OH⁻). A portion of the sodium hydroxide produced is used as a pH modifier in Lithium SX (FIGS. 3 and 6). The remainder may be considered a saleable by-product.

As illustrated in FIG. 6, in some embodiments, commercial sodium chloride salt is added to the NaCl electrolysis feed to produce a saturated NaCl solution prior to the NaCl electrolysis. A portion of the sodium hydroxide and potassium hydroxide produced by NaCl electrolysis may be used as a pH modifier in the nickel precipitation and lithium solvent extraction steps. The remainder, along with a portion of the chlorine gas produced, may be sent to bleach to generate sodium hypochlorite (NaClO) that may be used in the delithiation reaction.

The purified LiOH may be fed to a crude lithium hydroxide crystallizer where lithium hydroxide monohydrate solids are crystallized out of solution in an evaporator as crude lithium hydroxide. The discharge from the crude lithium hydroxide crystallizer may be a slurry stream comprising lithium hydroxide monohydrate solids in a saturated lithium hydroxide solution. The lithium hydroxide slurry from the crystallizer may be dewatered in a centrifuge.

As illustrated in FIGS. 4 and 5, in some embodiments, a portion of LiOH may be sent to the bleach areas to generate LiClO that may be used in the delithiation reaction. The dissolved lithium hydroxide is re-crystallized in another crystallizer as pure lithium hydroxide monohydrate. The pure lithium hydroxide slurry may be dewatered using a centrifuge and sent to LiOH·H₂O drying to remove excess moisture and produce a pure lithium hydroxide monohydrate product.

In some embodiments, purified lithium hydroxide or sodium hydroxide solution or dissolved Ca(OH)₂ (FIG. 2) may be reacted with chlorine gas in a conversion module to produce a solution comprising about equitnolar of chloride and hypochlorite (ClO). The solution may be used to regenerate a hypochlorite for any recycling process or delithiation process as provided herein. In some embodiments, the reaction is exothermic, and a heat exchanger may be used to control the hypochlorite solution temperature. The concentration of the hypochlorite solution is determined by the Li, Na, or Ca hydroxide solution concentration. The hypochlorite product solution may be recycled upstream to be used as an oxidant in the delithiation process.

In some embodiments, the chlorine and hydrogen gases produced in NaCl electrolysis and/or LiCl electrolysis may be combusted together to produce The hot hydrogen chloride is cooled and absorbed in water in an isothermal falling film absorber to form hydrochloric acid (33 wt %). A portion of the HCl may be recycled to be used as a stripping solution for the Ca or Li solvent extraction and as an eluent for ion exchange steps in some aspects, while the remainder may be recycled back to be used in the delithiation reaction.

FIGS. 2, 3, 5, and 6 include a lithium chloride electrolysis step, which is employed in some embodiments of the present disclosure. From a chemical perspective, lithium chloride electrolysis is similar to sodium or potassium chloride electrolysis. Its implementation differs because lithium ion in a cell may behave more like a proton than it does like other alkali metal ions, affecting the choice of membrane and requiring different internal cell hydraulics to achieve good performance. The alkali metal (i.e., lithium) crosses the cation exchange membrane to maintain the charge balance and produce lithium hydroxide on the cathode side. Any sodium and potassium present in the feed crosses the ion exchange membrane together with the lithium. There may be a minor selectivity in the cation exchange membrane, but the minor selectivity does not result in meaningful lithium/sodium separation. As a result, sodium and potassium will be present in the catholyte product in a similar ratio to the feed. LiCl brine may be fed to the anode chamber of the cell. At the anode, chlorine is evolved according to the following reaction:

Cl⁻→½Cl₂+e⁻ (1)

The current is carried largely by Li⁺ ions, which cross a cation exchange membrane that separates the anolyte and catholyte chambers. At the cathode, hydrogen and hydroxide ions are evolved according to the following reaction:

H₂O+e⁻→½H₂+OH⁻ (2)

LiOH is formed in the catholyte chamber. Products of the electrolysis include LiOH, Cl₂ gas, and H₂ gas. HCl is formed by combusting H₂ and Cl₂ in a separate HCl synthesis unit. The overall chemistry for the 2-compartment cell is:

LiCl+H₂O→½H₂½Cl₂+LiOH (3)

The reversible voltage is about 2 to about 5 V (e.g., about 2 to about 3.5 V), depending on pH of compartments.

Following precipitation, the resulting LiOH monohydrate product may be subsequently filtered, washed, and/or directly utilized for subsequent production of LNO materials, such as, e.g., for the production of lithiated cathode electrochemically active materials.

### EXAMPLES

The following examples are intended to be illustrative and are not meant in any way to limit the scope of the disclosure.

### Example Preparation of Delithiation Mother Liquor Using Lithium Hypochlorite

344 kg of water and 54 kg of lithium nickel oxide substantially free of other compounds was charged to an overhead stirred vessel to fluidize the solid material. 54 kg of concentrated hydrochloric acid and 228 kg of 12.3 wt. % lithium hypochlorite solution were charged to the vessel to cause oxidative delithiation of the lithium nickel oxide material. The vessel was operated at 50° C. for 3 hours after all reactants were charged to the vessel. After the chemical treatment, the solid was separated from the liquid using a filter press. The remaining solution was delithiation mother liquor for further treatment.

### Example Precipitation 1: Calcium and Nickel Precipitation from a Synthesized Feed Solution Using a 10% w/w LiOH Solution

The synthesized feed solution is made of mixed chloride salts in large quantities and mimics the solution generated by delithiation of LNO using calcium hypochlorite (see solution A, in table 2).

A 4-L glass leach vessel with a mixer, a pH electrode/meter, and a heating mantle was assembled. To the reactor was added a target amount of Feed solution, which was heated to a target temperature of 50° C. A 10% LiOH solution was slowly added to reactor until it reached a target pH of 10 (87 kg/m³ in feed solution). The target pH was maintained (±0.1) for 60 minutes. An 80 mL slurry was removed from the reactor, weighed, and filtered. The filtrate's weight, specific gravity (SG), pH, and oxidation reduction potential (ORP) were measured. A drop of concentrated HCl was added to the sample, an aliquot was separated for analysis (see solution B, Table 2), and the solids were returned to the reactor. To the reactor was then added a target amount of 25% Na₂CO₃ solution (5.9 kg/m³ in feed solution). The reactor contents were mixed for about 60 minutes. The weight of the final pulp was measured and the reactor contents filtered. The filtrate's weight, SG, pH, and ORP were measured, a drop of concentrated HCl was added, and an aliquot was separated for analysis (Solution C. Table 2). The solids were then washed with deionized (DI) water (2×500 mL displacement), and a dry sample was submitted for analysis (Final residue, Table 2).

TABLE 2

| | | Ca(ClO)₂:Synthetic | | | |
|---|---|---|---|---|---|
| | | feed solution A | | Solution C | Final |
| | | Batch #1 | Solution B | Final | Residue |
| | | Quantity (mL/g) | | | |
| Ele- | | 2000 | 3257 | 3293 | 175.1 |
| ment | Units | Assay (mg/L, %) | | | |
| Li | mg/L, % | 7950 | 25000 | 17700 | 0.33 |
| Na | mg/L, % | 16200 | 11600 | 9340 | 0.10 |
| K | mg/L, % | 256 | 142 | 142 | <0.00 |
| Ca | mg/L, % | 46500 | 35.4 | 45.4 | 53.0 |
| Mg | mg/L, % | 5.4 | 0.07 | 0.1 | 0.0 |
| Ni | mg/L, % | 2540 | 0.60 | 0.6 | 2.87 |

### Example Precipitation 2: Calcium and Nickel Precipitation from a Synthesized Feed Solution Using a 25% w/w NaOH Solution

The synthesized feed solution is made of mixed chloride salts in large quantities and mimics a solution generated by delithiation of LNO using calcium hypochlorite (solution A, Table 3).

A 4-L, glass leach vessel with a mixer, a pH electrode/meter, and a heating mantle was assembled. To the reactor was added a target amount of Feed solution after its weight and density were measured. The reactor was heated to a target temperature of 50° C. A 25% NaOH solution was slowly added to reactor until it reached a target pH of 11 (94.6 kg/m³ in feed solution.). The target pH was maintained (±0.1) for 60 minutes, An 80 mL slurry was removed from the reactor, weighed, and filtered (for analysis, see solution B, Table 3). To the reactor was then added a target amount of 30% Na₂CO₃ solution (3.9 kg/m³ in feed solution). The reactor contents were mixed for about 60 minutes. The weight of the final pulp was measured and the reactor contents filtered (for analysis see solution C, Table 3). The solids were then washed with deionized (DI) water (2×500 mL displacement), and a dry sample was submitted for analysis (final residue, Table 3).

TABLE 3

| | | Ca(ClO)₂:Synthetic | | | |
|---|---|---|---|---|---|
| | | Feed Solution A | | Solution C | Final |
| | | Batch #1 | Solution B | Final | Residue |
| | | Quantity (mL/g) | | | |
| Ele- | | 2000 | 2403 | 2427 | 174.5 |
| ment | Units | Assay (mg/L, %) | | | |
| Li | mg/L, % | 7950 | 5150 | 6200 | |
| Na | mg/L, % | 16200 | 46800 | 57500 | |
| K | mg/L, % | 256 | 179 | 212 | |
| Ca | mg/L, % | 46500 | 1450.0 | 735.0 | |
| Mg | mg/L, % | 5.4 | 0.6 | 0.1 | |
| Ni | mg/L, % | 2540 | 0.6 | 1.1 | |

### Example Precipitation 3: Calcium and Nickel Precipitation from a Synthesize Feed Solution Using a 10% w/w LiOH Solution

The synthesized feed solution is made of mixed chloride salts in large quantities and mimic a solution generated in delithiation of LNO using lithium hypochlorite (solution A, in table 4).

A 4-L glass leach vessel with a mixer, a pH electrode/meter, and a heating mantle was assembled. The density and weight of the Feed solution was measured. To the reactor was added a target amount of Feed solution, which was heated to a target temperature of 50° C. A 10% LiOH solution was slowly added to reactor until it reached a target pH of 10 (1.5 kg/m³ in feed solution or brine). The target pH was maintained (±0.1) for 60 minutes. An 80 ml, slurry was removed from the reactor, weighed, and filtered. The filtrate's weight, specific gravity (SG), pH, and oxidation reduction potential (ORP) were measured. A drop of concentrated HCl was added to the sample, an aliquot was separated for analysis, and the solids were returned to the reactor. The reactor contents were mixed for about 60 minutes. The weight of the final pulp was measured and the reactor contents filtered. The filtrate's weight, SG, pH, and ORP were measured, a drop of concentrated HCl was added, and an aliquot was separated for analysis (solution B, table 4). The solids were then washed with deionized (DI) water (2×500 mL displacement), and a dry sample was submitted for analysis (Final residue, table 4).

TABLE 4

| | | LiClO:Synthetic | | |
|---|---|---|---|---|
| | | Feed Solution A | | Final |
| | | Batch #2 | Solution B | Residue |
| | | Quantity (mL/g) | | |
| | | 2000 | 1831 | 3.2 |
| Element | Units | Assay (mg/L, %) | | |
| Li | mg/L, % | 10800 | 12300 | 12.5% |
| Na | mg/L, % | 2 | 16 | 0.6% |
| K | mg/L, % | 98 | 112 | 0.2% |
| Ca | mg/L, % | 9 | 2 | 4.8% |
| Mg | mg/L, % | 0.1 | 0.10 | 0.7% |
| Ni | mg/L, % | 1090 | 0.60 | 57.4% |

### Example: Ion Exchange (IX) Column Loading and Performance

1 L of 50 g/L NaOH was prepared using concentrated (50% w/w) NaOH. 100 mL of resin was washed with 2 BV (bed volume), 4 times with DI water to remove any degradation products. 100 mL of washed resin was measured and transferred into a suitable sized column (e.g., a 500 mL column), The NaOH solution was pumped into the column containing the resin in an up-flow fashion at 5 BV/h (=1250 milli or ˜20 mL/min) for 1 hour. The loaded resin was transferred into a Buchner filter and washed 4 times with DI water. 5 mL of loaded resin was collected and dried to a constant weight at 100° C.

For Ni precipitation, two precipitation tanks were used in series with a third tank as feed tank to the filtration. 10% LiOH solution was used for precipitation, and the delithiation mother liquor solution was fed at a rate of 200 mL/min. in one example, LiOH was added at a ratio of 50 wt %/50 wt % to the first and second tank at a flow rate of 0.5 g/min. Two ion exchange columns were used in series, with the second column worked as polishing in case of breakthrough.

TABLE 5

| | Feed to Ni | After Ni | |
|---|---|---|---|
| | Precipitation | Precipitation | After IX |
| Element | (ppm) | (ppm) | (ppm) |
| Li | 19100 | 18971 | 18757 |
| Ni | 239 | <1 | <1 |
| Ca | 2.9 | 4.4 | 1.6 |
| Mg | 0.43 | <0.07 | 0.086 |
| Si | 3.7 | 1.1 | 0.94 |

Various modifications of the present disclosure, in addition to those shown and described herein, will be apparent to those skilled in the art to which this disclosure pertains. Such modifications are also intended to fall within the scope of this disclosure.

It will further be appreciated by skilled artisans that all reagents are obtainable by sources known in the art unless otherwise specified.

This description of particular aspect(s) is merely exemplary in nature and is in no way intended to limit the scope of the disclosure or its application or uses, which may vary. Materials and processes are described with relation to the non-limiting definitions and terminology included herein. These definitions and terminology are not designed to function as a limitation on the scope or practice of the disclosure, but are presented for illustrative and descriptive purposes only. While the processes or compositions are described as an order of individual steps or using specific materials, those skilled in the art will appreciate that steps or materials may be interchangeable, such that the description of the disclosure may include multiple parts or steps arranged in many ways as is readily appreciated by one of skill in the art.

It will be understood that, although the terms “first,” “second,” “third,” etc. may be used herein to describe various elements, components, regions, layers, and/or sections, these elements, components, regions, layers, and/or sections should not be limited by the use of these terms. These terms are only used to distinguish one element, component, region, layer, or section from another element, component, region, layer, or section. Thus, a first “element,” “component,” “region,” “layer,” or “section” discussed below could be termed a second (or other) element, component, region, layer, or section without departing from the teachings herein.

The terminology used herein is for the purpose of describing particular aspects of the disclosure only and is not intended to be limiting. As used herein, the singular forms “a,” “an,” and “the” are intended to include the plural forms, including “at least one” or “one or more,” unless the content clearly indicates otherwise. Additionally, as used herein, “or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. The term “or a combination thereof” means a combination including at least one of the foregoing elements.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

In some embodiments, the term “about” or “approximately” means within 1, 2, 3, or 4 standard deviations of a value. In some embodiments, the term “about” or “approximately” means within 30%, 25%, 20%, 15%, 10%, 9%. 8%, 7%, 6%, 5%, 4%, 3%, 2%, 1%, 0.5%, 0.1%, or 0,05% of a given value or range.

Patents, publications, and applications mentioned in the specification are indicative of the levels of those skilled in the art to which the disclosure pertains. These patents, publications, and applications are incorporated herein by reference to the same extent as if each individual patent, publication, or application was specifically and individually incorporated herein by reference.

The foregoing description is illustrative of particular aspects of the disclosure, but is not meant to be a limitation upon the practice thereof.

1. A process for isolating lithium and/or nickel comprising:
(A) delithiating a lithium nickel oxide (LNO) material in the presence of a mineral acid and a hypochlorite salt to produce a delithiated nickel oxide (DLNO) material and a waste stream, wherein the waste stream comprises a chloride ion, a lithium ion, and a nickel ion; and
(B1) precipitating Ni(OH)₂ from the waste stream to produce a lithium rich solution.

2. The process according to claim 1, wherein the hypochlorite salt is selected from calcium hypochlorite salts, lithium hypochlorite salts, and sodium hypochlorite salts.

3. The process according to claim 1, further comprising treating the waste stream by solvent extraction in the presence of input LiOH, input NaOH, or a combination thereof

4. (canceled)

5. A process for isolating lithium and/or nickel comprising:
(A) delithiating a lithium nickel oxide (LNO) material in the presence of HCl and a hypochlorite salt to produce a delithiated nickel oxide (DLNO) material and a waste stream, wherein the waste stream comprises a chloride ion, a lithium ion, and a nickel ion; and
(B2) treating the waste stream by solvent extraction in the presence of input LiOH, input NaOH, or a combination thereof to produce a lithium rich solution.

6. The process according to claim 1, wherein the lithium rich solution comprises one or more multivalent ions.

7. (canceled)

8. The process according to claim 1, further comprising:
(D1) subjecting the lithium rich solution to ion exchange to remove at least some multivalent ions other than Li⁺ and produce a LiCl stream.

9. The process according to claim 8, wherein:
the hypochlorite salt is chosen from calcium hypochlorite salts and sodium hypochlorite salts; and
step (D1) further comprises:
subjecting the lithium rich solution to solvent extraction in the presence of input HCl to remove at least some multivalent ions to produce the LiCl stream;
separating Na from the LiCl stream using solvent extraction to produce a NaCl stream; and
optionally concentrating the LiCl stream.

10. The process according to claim 9, further comprising subjecting at least a portion of the NaCl stream to electrolysis to produce NaOH, a H₂ gas, and a Cl₂ gas, and optionally further comprising any of (1) subjecting at least a portion of the H₂ gas to an HCl burner to produce HCl, or (2) reacting at least a portion of the Cl₂ gas with Ca(OH)₂ or NaOH to produce calcium hypochlorite or sodium hypochlorite.

11. (canceled)

12. (canceled)

13. The process according to claim 1, wherein:
the hypochlorite salt is a lithium hypochlorite salt; and
the process further comprises:
(D2) converting the lithium rich solution to a Li₂CO₃ stream
wherein step (D2) optionally comprises:
treating the lithium rich solution with soda ash to produce the Li₂CO₃ stream.

14. (canceled)

15. The process according to claim 8, further comprising:
(E) isolating LiOH from the LiCl stream, wherein the isolated LiOH is optionally in a liquid form, a crystalline form, or both, and optionally reacting at least a portion of the isolated LiOH with a Cl₂ gas to produce lithium hypochlorite or crystallizing LiOH monohydrate from at least a portion of the isolated LiOH.

16.-19. (canceled)

20. The process according to claim 15, wherein step (E) comprises:
(F) subjecting the LiCl stream to electrolysis to produce a LiOH liquid, a H₂ gas, and a Cl₂ gas; and
(G) precipitating LiOH monohydrate from the LiOH liquid, and optionally, subjecting at least a portion of the H₂ gas to an HCl burner in the presence of at least a portion of the Cl₂ gas to produce HCl, or reacting at least a portion of the Cl₂ gas with Ca(OH)₂ to produce calcium hypochlorite, or reacting at least a portion of the LiOH liquid with at least a portion of the Cl₂ gas to produce lithium hypochlorite.

21.-23. (canceled)

24. The process according to claim 15, wherein step (E) comprises:
separating Li from Na in the LiCl stream using solvent extraction in the presence of input NaOH to produce NaCl;
optionally concentrating the LiCl stream to produce a concentrated LiCl stream; and
subjecting the LiCl stream or the concentrated LiCl stream to electrolysis to convert the LiCl to a LiOH liquid, a H₂ gas, and a Cl₂ gas.

25. The process according to claim 24, further comprising at least one of:
a) precipitating LiOH monohydrate from the LiOH liquid,.
b) subjecting at least a portion of the H₂ gas to an HCl burner, optionally in the presence of at least a portion of the Cl₂ gas, to produce HCl,
c) reacting at least a portion of the Cl₂ gas with Ca(OH)₂ to produce calcium hypochlorite, or
d) subjecting at least a portion of the produced NaCl to electrolysis to produce NaOH.

26.-28. (canceled)

29. The process according to claim 13, wherein further comprising a step (E) of:
treating the Li₂CO₃ stream with calcium hydroxide to produce LiOH and CaCO₃.

30 The process according to claim 29, further comprising:
subjecting at least a portion of the LiOH obtained in step (E) to ion exchange; and
crystallizing the ion exchanged LiOH to obtain battery grade lithium hydroxide monohydrate or reacting at least a portion of the ion-exchanged LiOH with Cl₂ gas to produce lithium hypochlorite.

31. (canceled)

32. The process according to claim 1, wherein satisfying at least one of the following:
a) the process is continuous
b) a process input is produced during the operation of the process and recycled in the process,
c) the mineral acid is HCl, or
d) the waste stream has a pH of 2 6.

33.-35. (canceled)

36. The process according to claim 1, wherein the LNO material is chosen from LiNiₓM_{y}O_{z} materials, wherein:
M is chosen from Ni, Co, Mn, Ti, Zr, Nb, Hf, V, Cr, Sn, Cu, Mo, W, Fe, Si, B, and combinations of any of the foregoing;
x is chosen from numbers from 0 to 1.999;
y is chosen from numbers from 0 to 1.999; and
z is chosen from numbers from 1 to 4.

37. (canceled)

38. (canceled)

39. The process according to claim 36, wherein the LNO material is chosen from LiNiMO_{z} materials, and is optionally LiNiCoAlO_{z} and LiNiCoAlM′O_{z} materials, wherein M′ is chosen from metals.

40. (canceled)

41. The process according to claim 1, further comprising forming a LNO material using Ni(OH)₂ produced by the process, LiOH monohydrate produced by the process, or both.

42. A process for isolating lithium and/or nickel comprising:
(A) delithiating a lithium nickel oxide (LNO) material in the presence of a mineral acid and a calcium hypochlorite salt to produce a delithiated nickel oxide (DLNO) material and a waste stream, wherein the waste stream comprises a chloride ion, a lithium ion, and a nickel ion;
(B) precipitating Ni(OH)₂ from the waste stream to produce a lithium rich solution;
(C) optionally concentrating the lithium rich solution to produce a concentrated lithium rich solution;
(D) subjecting the lithium rich solution or the concentrated lithium rich solution to ion exchange to remove at least some multivalent ions other than Li⁺ and produce a LiCl stream;
(E) subjecting the LiCl stream to electrolysis to produce a LiOH liquid, a H₂ gas, and a Cl₂ gas;
(F) precipitating LiOH monohydrate from the LiOH liquid;
(G) reacting (i) at least a portion of the LiOH liquid and/or (ii) redissolved LiOH monohydrate, with at least a portion of the Cl₂ gas to produce lithium hypochlorite; and
(H) subjecting at least a portion of the H₂ gas to an HCl burner in the presence of at least a portion of the Cl₂ gas to produce HCl.

43. (canceled)
